(19) United States
(12) Patent Application Publication
(10) Pub. No.: US 2015/0254259 A1
(43) Pub. Date: Sep. 10, 2015

(54) Method, System And Computer Memory Medium For Searching Based On Geography Position

(71) Applicant: TENCENT TECHNOLOGY (SHENZHEN) COMPANY LIMITED, Shenzhen City (CN)

(72) Inventor: Hua FAN, Shenzhen (CN)

(21) Appl. No.: 14/717,427

(22) Filed: May 20, 2015

Related U.S. Application Data
(63) Continuation of application No. PCT/CN2013/085416, filed on Oct. 17, 2013.

(30) Foreign Application Priority Data
Nov. 26, 2012 (CN) 201210486582.X

(51) Int. Cl. G06F 17/30; G01S 19/13

(52) U.S. Cl. CPC G06F 17/3087; G06F 17/30622; G01S 19/13

(57) ABSTRACT

A method, system and computer memory medium is provided for searching based on geography position. The method includes establishing a mapping relationship between a location coordinate (LC) and a material or between an LC range and a material. The method further includes converting location information of a searching terminal into a corresponding LC or LC range, and searching for the mapping relationship according to the LC or LC range obtained by conversion to obtain a corresponding material.

### CROSS-REFERENCE TO RELATED APPLICATIONS

This application is a continuation of International Application No. PCT/CN2013/085416, filed Oct. 17, 2013. This application claims the benefit and priority of Chinese Application No. 201210486582.X, filed Nov. 26, 2012. The entire disclosures of each of the above applications are incorporated herein by reference.

### FIELD

The present disclosure relates to a method, system, and computer memory medium for searching based on geography position.

### BACKGROUND

This section provides background information related to the present disclosure which is not necessarily prior art.

A search refers to a process in which an Internet user triggers, by using a terminal device such as a personal computer (PC) or a mobile phone, a logic-related search result in a background matching system by submitting a query in a text box of a search engine. Currently, accuracy of a geographical location-based search is relatively low, and search results often cannot meet a preference of the user regarding geographical location.

### SUMMARY

This section provides a general summary of the disclosure, and is not a comprehensive disclosure of its full scope or all of its features.

Various embodiments of the present disclosure provide a geographical location-based search method, system and computer memory medium, so as to at least improve accuracy of a geographical location-based search.

Various embodiments provide a method for searching based on geography position, including:

establishing a mapping relationship between a location coordinate (LC) and a material or between an LC range and a material; and

converting location information of a searching terminal into a corresponding LC or LC range and searching for the mapping relationship according to the LC or LC range obtained by conversion to obtain a corresponding material.

Various embodiments further provide a system for searching based on geography position, including:

a mapping relationship establishment module, configured to establish a mapping relationship between an LC and a material or between an LC range and a material;

a location service module, configured to convert location information of a searching terminal into a corresponding LC or LC range; and

a search module, configured to search for the mapping relationship according to the LC or LC range obtained by conversion by the location service module, to obtain a corresponding material.

Various embodiments further provide a computer memory medium, the memory medium including a group of instructions and, when the instructions are executed, at least one processor executing operations including the following:

establishing a mapping relationship between an LC and a material or between an LC range and a material;

converting location information of a searching terminal into a corresponding LC or LC range; and

searching for the mapping relationship according to the LC or LC range obtained by conversion, to obtain a corresponding material.

According to a method, system and computer memory medium for searching based on geography position that are provided according to the various embodiments, a mapping relationship between an LC and a material or between an LC range and a material is established and location information of a searching terminal is converted into a corresponding LC or LC range and the mapping relationship is searched for according to the LC or LC range obtained by conversion, to obtain a corresponding material. Through the foregoing method, the accuracy of a geographical location-based search can be improved.

Further areas of applicability will become apparent from the description provided herein. The description and specific examples in this summary are intended for purposes of illustration and are not intended to limit the scope of the present disclosure.

### DRAWINGS

The drawings described herein are for illustrative purposes of selected embodiments and not all possible implementations, and are not intended to limit the scope of the present disclosure.

FIG. 1 is a flowchart of a geographical location-based search method according to various embodiments;

FIG. 2 is a structural diagram of a geographical location-based search system according to various embodiments; and

FIG. 3 is a diagram of search operations executed by a search system according to various embodiments.

Corresponding reference numerals indicate corresponding parts throughout the several views of the drawings.

### DETAILED DESCRIPTION

Example embodiments will now be described more fully with reference to the accompanying drawings.

The following further describes the technical methods of the present disclosure in detail with reference to the accompanying drawings and various embodiments.

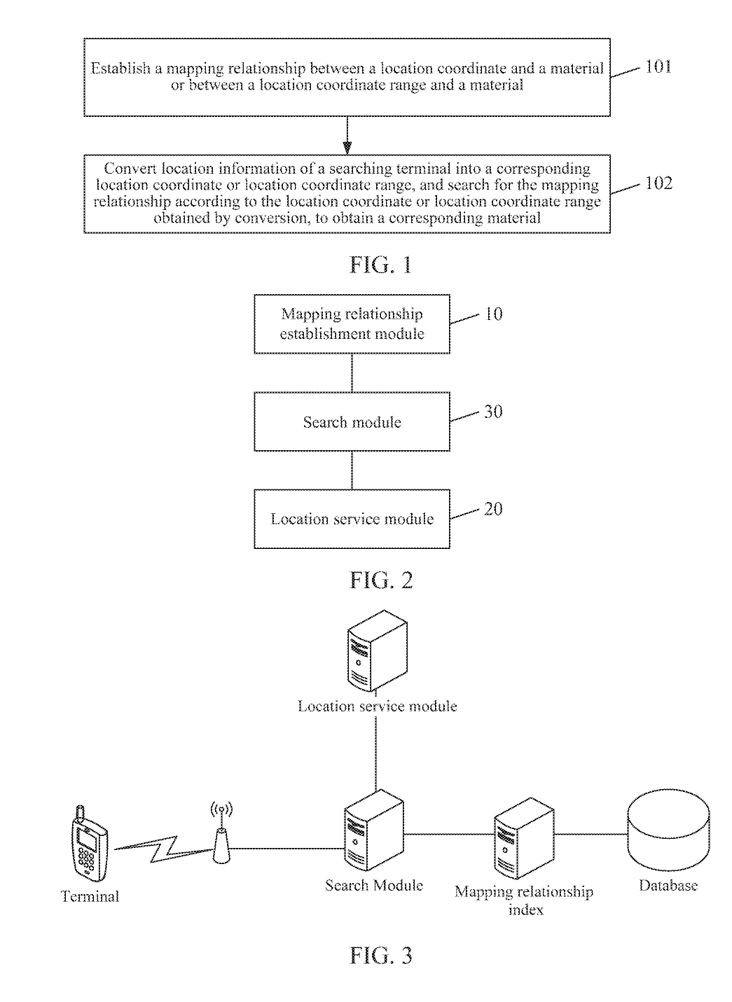

As shown in FIG. 1, a geographical location-based search method provided according to various embodiments mainly includes the following.

S101: Establish a mapping relationship between an LC and a material or between an LC range and a material. The LC refers to coordinates capable of accurately representing any point and place on the earth. The LC may be latitude and longitude values, global position address codes, and the like. Any location on the earth may be distinguished, identified, and positioned by using the LC. The material refers to content that can be used as a search result and can be found through searching by a user.

Establishing a mapping relationship between an LC and a material or between an LC range and a material includes:

establishing the mapping relationship according to an input LC or LC range, and an input material; or

calculating a corresponding LC or LC range according to a selected geographical area and establishing the mapping relationship according to the LC or LC range obtained by calculation and an input material.

The LC marks a specific geographical location on the earth, for example, an LC [80a37b39c26d] [32a32b14c07d] marks a specific geographical location point, where [80a37b39c26d] marks a horizontal coordinate and [32a32b14c07d] marks a longitudinal coordinate. The LC range marks a geographical area or a geographical area range on the earth, for example, an LC range [80a37b39c26d] [32a32b14c07d] to [80a37b44c26d] [32a32b44c07d] marks a specific geographical area range.

The mapping relationship between an LC and a material or between an LC range and a material may be stored in a matching system in an inverted index manner. In the mapping relationship, a same LC or LC range may correspond to at least one material and the same material may correspond to at least one LC or LC range.

S102: Convert location information of a searching terminal into a corresponding LC or LC range, and search for the mapping relationship according to the LC or LC range obtained by conversion to obtain a corresponding material. The location information of the terminal includes, but is not limited to, at least one of Global Position System (GPS) location information of the terminal, a cell identifier of the terminal, and a Wireless Local Area Network Media Access Control (WLAN MAC) address of the terminal.

Various embodiments further provide a geographical location-based search system. As shown in FIG. 2, the system includes a mapping relationship establishment module 10, a location service module 20, and a search module 30. The mapping relationship establishment module 10 is configured to establish a mapping relationship between an LC and a material or between an LC range and a material, where the mapping relationship may be stored in a dedicated database. The location service module 20 is configured to convert location information of a searching terminal into a corresponding LC or LC range. The search module 30 is configured to search for the mapping relationship according to the LC or LC range obtained by conversion by the location service module 20, to obtain a corresponding material.

The mapping relationship establishment module 10 is further configured to:

establish the mapping relationship according to an input LC or LC range and an input material; or

calculate a corresponding LC or LC range according to a selected geographical area and establish the mapping relationship according to the LC or LC range obtained by calculation, and an input material.

The mapping relationship between an LC and a material or between an LC range and a material is stored in an inverted index manner. In the mapping relationship, a same LC or LC range corresponds to at least one material and a same material corresponds to at least one LC or LC range.

The location information of the terminal includes at least one of GPS location information of the terminal, a cell identifier of the terminal, a WLAN MAC address of the terminal, and the like.

It should be noted that functions of the mapping relationship establishment module 10, the location service module 20, and the search module 30 according to various embodiments may be implemented by a central processing unit (CPU), a micro processing unit (MPU), a digital signal processor (DSP), or the like in the search system.

The following describes, in detail with reference to FIG. 3, a search operation implemented by the search system according to various embodiments. As shown in FIG. 3, a mapping relationship establishment module (not shown in the figure) establishes a mapping relationship between an LC and a material or between an LC range and a material, where the mapping relationship is stored in a dedicated database, or, a function of the mapping relationship establishment module may also be integrated into a database. Moreover, the database can provide an index of the mapping relationship to facilitate a search, a location service module converts location information of a searching terminal into a corresponding LC or LC range and provides the LC or LC range for a search module, and the search module searches the database according to the LC or LC range provided by the location service module and finds a corresponding material by using the mapping relationship.

The LC or LC range according to various embodiments may be one (that is, a location-based trigger condition) of trigger conditions for a material, which is used in combination with other common trigger conditions (that is, non-location-based trigger conditions) for a material, so as to trigger a search for a corresponding material together. Search results may be ranked in a queue according to a set policy and first n search results (materials) of the queue are returned to a terminal.

The integrated modules according to various embodiments may also be stored in a computer readable memory medium when the modules are implemented in a form of a software functional module and sold or used as an independent product. Based on such an understanding, the technical methods of the various embodiments essentially or the part contributing to the existing technology may be implemented in a form of a software product. The computer software product is stored in a memory medium and includes several instructions for instructing a computer device (which may be a personal computer, a server, a network device, or the like) to perform all or a part of the methods according to the various embodiments. The foregoing memory medium includes any medium that can store program code, such as a USB flash drive, a removable hard disk, a read-only memory (ROM), a random access memory (RAM), a magnetic disk, or an optical disc. Therefore, the various embodiments are not limited to any specific combination of hardware and software.

Correspondingly, various embodiments further provide a computer memory medium. The memory medium includes a group of instructions and when the instructions are executed, at least one processor executes operations including the following:

establishing a mapping relationship between an LC and a material or between an LC range and a material;

converting location information of a searching terminal into a corresponding LC or LC range; and

searching for the mapping relationship according to the LC or LC range obtained by conversion, to obtain a corresponding material.

The memory medium further includes instructions enabling at least one processor to execute the following operations, and the operations include:

establishing the mapping relationship according to an input LC or LC range, and an input material; or

calculating a corresponding LC or LC range according to a selected geographical area and establishing the mapping relationship according to the LC or LC range obtained by calculation and an input material.

The memory medium further includes instructions enabling at least one processor to execute the following operations, and the operations include storing the mapping relationship between an LC and a material or between an LC range and a material in an inverted index manner. In the mapping relationship, a same LC or LC range corresponding to at least one material and a same material corresponding to at least one LC or LC range. The location information of the terminal includes at least one of GPS location information of the terminal, a cell identifier of the terminal, and a WLAN MAC address of the terminal.

The above descriptions are merely preferred embodiments, but are not intended to limit the protection scope of the present disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A geographical location-based search method, comprising:
establishing a mapping relationship between a location coordinate (LC) and a material or between an LC range and a material;
converting location information of a searching terminal into a corresponding LC or LC range; and
searching in the mapping relationship according to the LC or LC range obtained by conversion, to obtain a corresponding material.

2. The geographical location-based search method according to claim 1, wherein the establishing a mapping relationship between an LC and a material or between an LC range and a material comprises:
establishing the mapping relationship according to an input LC or LC range, and an input material; or
calculating a corresponding LC or LC range according to a selected geographical area, and establishing the mapping relationship according to the LC or LC range obtained by calculation, and an input material.

3. The geographical location-based search method according to claim 1, wherein the mapping relationship between an LC and a material or between an LC range and a material is stored in an inverted index manner.

4. The geographical location-based search method according to claim 1, wherein, in the mapping relationship, a same LC or LC range corresponds to at least one material and a same material corresponds to at least one LC or LC range.

5. The geographical location-based search method according to claim 1, the location information of the terminal comprises at least one of the following:
Global Position System (GPS) location information of the terminal, a cell identifier of the terminal, and a Wireless Local Area Network Media Access Control (WLAN MAC) address of the terminal.

6. A geographical location-based search system, comprising:
a mapping relationship establishment module, configured to establish a mapping relationship between a location coordinate (LC) and a material or between an LC range and a material;
a location service module, configured to convert location information of a searching terminal into a corresponding LC or LC range; and
a search module, configured to search for the mapping relationship according to the LC or LC range obtained by conversion by the location service module, to obtain a corresponding material.

7. The geographical location-based search system according to claim 6, wherein the mapping relationship establishment module is further configured to:
establish the mapping relationship according to an input LC or LC range, and an input material; or
calculate a corresponding LC or LC range according to a selected geographical area, and establish the mapping relationship according to the LC or LC range obtained by calculation, and an input material.

8. The geographical location-based search system according to claim 6, wherein the mapping relationship between an LC and a material or between an LC range and a material is stored in an inverted index manner.

9. The geographical location-based search system according to claim 6, wherein, in the mapping relationship, a same LC or LC range corresponds to at least one material and a same material corresponds to at least one LC or LC range.

10. The geographical location-based search system according to claim 6, the location information of the terminal comprises at least one of the following:
Global Position System (GPS) location information of the terminal, a cell identifier of the terminal, and a Wireless Local Area Network Media Access Control (WLAN MAC) address of the terminal.

11. A computer memory medium, the memory medium comprising a group of instructions and when the instructions are executed, at least one processor executing operations comprising the following:
establishing a mapping relationship between a location coordinate (LC) and a material or between an LC range and a material;
converting location information of a searching terminal into a corresponding LC or LC range; and
searching for the mapping relationship according to the LC or LC range obtained by conversion, to obtain a corresponding material.

12. The computer memory medium according to claim 11, wherein the memory medium further comprises instructions enabling at least one processor to execute the following operations, and the operations comprise:
establishing the mapping relationship according to an input LC or LC range, and an input material; or
calculating a corresponding LC or LC range according to a selected geographical area, and establishing the mapping relationship according to the LC or LC range obtained by calculation, and an input material.

13. The computer memory medium according to claim 11, wherein the memory medium further comprises instructions enabling at least one processor to execute the following operations, and the operations comprise:
storing the mapping relationship between an LC and a material or between an LC range and a material in an inverted index manner.

14. The computer memory medium according to claim 11, wherein in the mapping relationship, a same LC or LC range corresponding to at least one material and a same material corresponding to at least one LC or LC range.

15. The computer memory medium according to claim 11, wherein the location information of the terminal comprises at least one of the following:
Global Position System (GPS) location information of the terminal, a cell identifier of the terminal, and a Wireless Local Area Network Media Access Control (WLAN MAC) address of the terminal.
